(19) United States
(12) Patent Application Publication
(10) Pub. No.: US 2010/0281496 A1
(43) Pub. Date: Nov. 4, 2010

(54) Program Subscription Method and System

(75) Inventor: Michael Carew, Surrey Hills (AU)

Correspondence Address: FENWICK & WEST LLP, SILICON VALLEY CENTER, 801 CALIFORNIA STREET, MOUNTAIN VIEW, CA, 94041, US

(73) Assignee: Tradsol Pty Ltd, Surrey Hills (AU)

(21) Appl. No.: 12/434,904

(22) Filed: May 4, 2009

(51) Int. Cl. H04N 7/16; G06F 13/00

(52) U.S. Cl. 725/5; 725/51; 725/54; 725/109

(57) ABSTRACT

A system for accessing video content or audio content over the internet comprising a server linked to the internet and storing the video content or audio content; a nominated terminal device of a subscriber to access the video content or audio content; and a graphical interface enabling the subscriber to select available programs from the audio or video content for viewing or listening on the nominated terminal device. The selection of programs is transmitted over the internet to the server and the server transmits the selected programs or links to the selected programs to the nominated terminal device for access by the subscriber for a predetermined period of time.

### FIELD OF THE INVENTION

This invention relates to a program subscription method and system. More particularly, the invention relates to a method and system for enabling subscribers to access video content or audio content on a terminal device.

### BACKGROUND OF THE INVENTION

Where a person is unable to watch or listen to a program, for example, on television or the radio, he or she has to rely on some means of recording that program so as to watch it or listen to it at a later time. Presently the availability to record video programs is either through a conventional VCR machine, DVD recording machine or a hard disc recorder associated with a television, DVD player or audio recording device.

The problem with relying on such recordings is that for a number of reasons the recording may not actually be made. Firstly, it requires the person to enter the correct time on the recorder for when the program is being broadcast, assuming the person remembers to program the recorder, the program may be run at a different time to the advertised time by a network or not broadcast at all. Furthermore, the person has to rely on having enough time left on a recording medium in order to record such a program. If any of the above scenarios occur then the person will not be able to watch the program or listen to the program.

Pay television subscription has existed for a number of years in some countries and offers the availability to watch programs over the course of a day or a week. Often these programs are replayed after initial broadcast by free-to-air television or radio networks. Again, a person would have a similar problem in that in order to watch a program, if they are not able to watch or listen to a program at the advertised times, they have to rely on recording the program and therefore invoke potentially the above disadvantages.

Free-to-air television and radio networks have made available, through the internet, audio and video recordings of selected works which are chosen by the networks themselves. There is no choice as to what a person can listen to or watch and also has to be listening or watching at a particular time or within a certain duration of times, for example, over the course of a single day. This may not be convenient for the person who could be away or out of contact or unable to access the internet assuming that there is a program, whether video or audio, that the person wishes to see or hear.

The present invention seeks to overcome one or more of the above disadvantages by providing a system that enables the person to have access to an audio or visual program on a terminal device, such as a PC or mobile phone, whereby the program is accessed at a convenient time to the person.

### SUMMARY OF THE INVENTION

According to a first aspect of the invention, there is provided a method of accessing video content or audio content over the internet, the method comprising the steps of:

subscribing to receive the video content or audio content;

the subscriber selecting available programs using a graphical interface for viewing or listening on a nominated terminal device;

transmitting the selection to a server;

transmitting the selected programs or links to the selected programs from the server to the nominated terminal device whereupon the subscriber is able to access the programs for a predetermined period of time.

The selection of programs by the subscriber may be based on programs that are to be recorded and subsequently transmitted to the terminal device. Alternatively, the selection of programs by the subscriber may be based on programs, being video or audio content, that have previously been broadcast.

The method may further include the step of transmitting from a server, means for providing a subscriber with the graphical interface on the terminal device of the subscriber.

The selected programs may be stored in a memory of the terminal device when there is no connection available over the internet. When a connection over the internet is established, the selected programs or changes to the selected programs may be transmitted to the server. Changes may include the deletion or inclusion of a program or changes to the time and frequency of delivery to the terminal device. This may include changes to programs selected for recording.

The means for providing the graphical interface may be a computer program that is downloaded to the subscriber terminal device upon receipt and approval by the server of personal details of, and payment for the subscription, by the subscriber. Alternatively the means for providing the graphical interface may be a computer program that is stored at the server so that the subscriber accesses the interface at a website.

The terminal device may be a landline PC, including a laptop or a notebook. Alternatively, the terminal device may be any one of a mobile telephone, a mobile PDA, mobile PC, portable multimedia device such as an MP3 player. The device may be connected to the internet through a mobile communications network.

Preferably the subscriber nominates which of their terminal devices they wish to view the program or listen to the program.

The graphical interface may display the name of a program, the time and frequency and the start date each program is or will be available for downloading or recording. In the case of a program yet to be broadcast, the start time and end time is displayed and the subscriber can select a program to be recorded by making an entry on the terminal device. The programs to be recorded may be recorded and stored at the server.

The subscriber may select, in addition to each program, a time, date and frequency of download of each program to the terminal device, either downloaded as the entire program (for local storage) or as hyperlinks to each program, available at the server. Where hyperlinks to each selected program is transmitted to the terminal device, the video or audio of the program may be streamed.

The server may receive audio and/or video content from servers associated with any one of television networks, radio networks, film studios, or websites associated with any of these networks or studios or any other media. The content can be received by the server after broadcast or telecast by such networks, or at the time of the broadcast or telecast. Any programs selected by subscribers for recording are recorded and stored in a storage medium at the server, having storage allocated to each such subscriber. The storage medium may be part of a virtual hard disk recorder in which recordings of content have been made, but which cannot be displayed all simultaneously (among the various subscribers). The programs, once recorded and stored, can be downloaded to the nominated terminal device within a set period of time.

According to a second aspect of the invention, there is provided a system for accessing video content or audio content over the internet, the system comprising:

a server linked to the internet and storing the video content or audio content;

a nominated terminal device of a subscriber to access the video content or audio content;

a graphical interface enabling the subscriber to select available programs from the audio or video content for viewing or listening on the nominated terminal device;

wherein the selection of programs is transmitted over the internet to the server and the server transmits the selected programs or links to the selected programs to the nominated terminal device for access by the subscriber for a predetermined period of time.

The selection of programs may be based on video content or audio content that has previously been broadcast. The selection of programs may be based on video content or audio content that is to be recorded and subsequently transmitted to the terminal device.

The system may further comprise means for providing the subscriber with the graphical interface on the terminal device.

According to a third aspect of the invention, there is provided computer program means for providing access to video content or audio content over the internet, the computer program means instructing a processor to:

provide a graphical interface to the video or audio content that enables selection of available programs from the content for viewing on or listening on a nominated terminal device;

transmit the selected programs over the internet to a server; receive from the server the selected programs or links to the selected programs; and

enable the subscriber to access the programs for a predetermined period of time.

The selection of programs may be based on video content or audio content that has previously been broadcast. The selection of programs may be based on video content or audio content that is to be recorded and subsequently transmitted to the terminal device.

The computer program means may be transmitted to the nominated terminal device of a subscriber over the internet. The graphical interface may be provided on the terminal device through the computer program means.

### BRIEF DESCRIPTION OF THE DRAWINGS

A preferred embodiment of the invention will hereinafter be described, by way of example only, with reference to the drawings, wherein:

FIG. 1 is a block diagram of a system that enables a subscriber to access video or audio content on a terminal device at a time of their choosing;

FIG. 2 is a screen image of a graphical user interface for enabling selection of video or audio content;

FIG. 3 is a flow diagram showing the process involved in a user obtaining a subscription and eventually having access to the video or audio content; and

FIG. 4 is a flow diagram showing steps undertaken by software installed on the subscriber terminal device and software used at a system server.

### DETAILED DESCRIPTION OF THE PREFERRED EMBODIMENTS

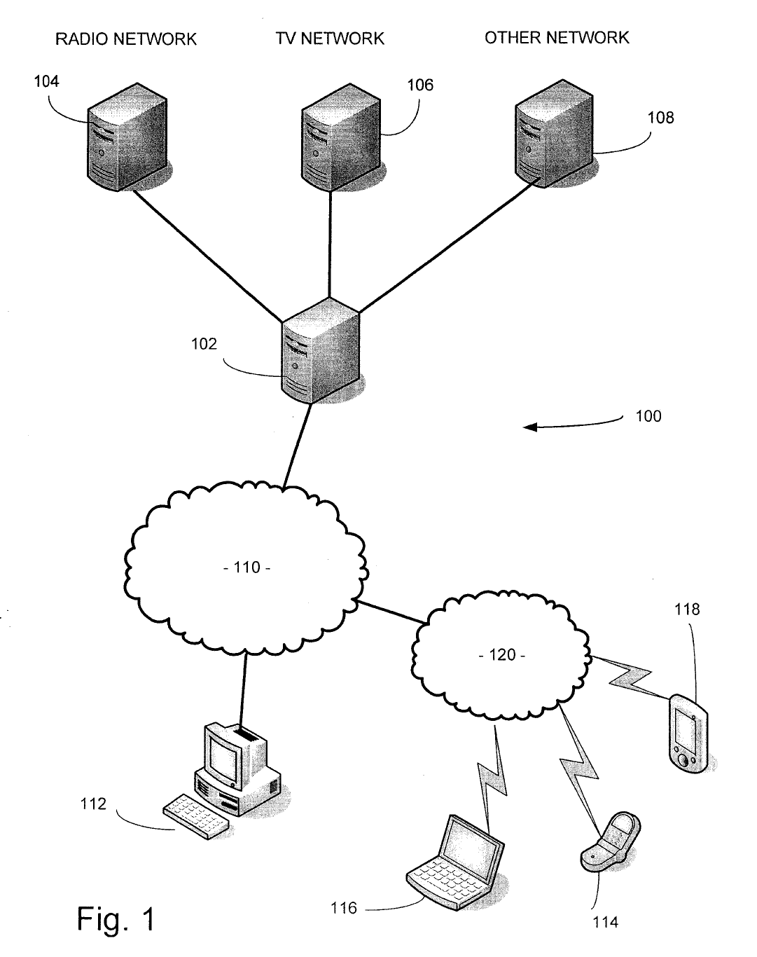

Referring to FIG. 1 there is shown a block diagram of a system 100 that enables a subscriber access to visual and audio content. In a first embodiment, the visual and audio content has previously been broadcast, for example, by free-to-air networks, and can be accessed at a time or day chosen by the subscriber. In a second embodiment, the visual and audio content is recorded on request from the subscriber. The system 100 has a system server 102 that is linked to respective servers 104, 106, 108 of a radio network, a television network or other network representative of audio or visual content.

The server 102 is connected to the internet 110. Also connected to the internet 110 is a terminal device, such as a PC 112 used by a subscriber or other devices such as mobile phone 114, portable computing device, in the form of a notebook 116, PDA 118 or other portable multimedia device such as MP3 players. These are connected to the internet 110 through a mobile telephone network or alternatively a VoIP network 120.

With reference to the first embodiment, the radio network server 104 will have stored therein various audio files, which may, for example, be music, talk back discussions or interviews which are delivered to or retrieved by the server 102 for storage at the server 102. Similarly, with regard to the television network server 106, it has stored therein broadcast programs for a certain time period such as news programs, current affairs or other streamed media that may be available. This is in addition to serial programs particular to a network, films, documentaries and other such programs. These are also delivered to or retrieved by the server 102 for temporary storage at server 102. Similarly, another network server 108 may store video and audio files from already broadcast programs that can be available for viewing by subscribers and is transferred to or accessed by server 102 for storage at a storage medium at server 102. An agreement would be made between the host of server 102 and the various networks as to what video and audio content can be transmitted to and used by the operator of server 102. It is these stored programs of audio and video content that a subscriber can have activated on their terminal device, such as mobile phone 114 or computer 112.

Referring to the second embodiment, the server 102 accepts transmission feeds of video and audio content from any of the radio network(s), television network(s) or other network(s) respectively having servers 104, 106 and 108. A subscriber accesses an interface, either at a website or via software downloaded to one of the subscriber's terminal devices, in order to select programs that the subscriber wishes to have recorded and later downloaded to the nominated subscriber device. The subscriber simply selects the program or programs which would each have a title, date, start and finish time and channel from which the program is broadcast or telecast and transmits this selection to the server 102. The subscriber also nominates, at the time of registration, which terminal device the content is to be viewed on or downloaded to. The server 102 transmits the content at a time chosen by the subscriber, or transmits links to the content, to the nominated device. Where links are provided, the subscriber simply clicks on the link to have the content, stored at the server 102, downloaded to the subscriber's device. It is to be noted that the subscriber need not record a particular program, but can perform time-based recording instead. As an example the subscriber may record a program from a particular television channel for a predetermined period of time, say 6 pm to 8.30 pm.

The server 102 includes a virtual hard disk recorder, which keeps memory sectors available to each subscriber who has requested a recording, in order to temporarily store the recording. The sectors can be identified by a subscriber number, email address or terminal device number, as examples. The recorder records the nominated program at the set time and stores it in the allocated memory sector(s). As an example, where many subscribers have requested recordings, the server 102 can allocate one hour or a few hours or recording space in memory for each subscriber.

The server 102 including the hard disk recorder may be supplied to the subscribers, whereby disk space or memory, software and hardware required to record programs is supplied to each subscriber. Thus, each subscriber records their own programs or undertakes their own recording. It is similar to the subscribers leasing or hiring the hard disk recorder. Each subscriber can pay a fee to buy the required disk space and obtain a license to use the hardware and software to enable recording of available content.

In order to subscribe to receiving such content, a user will typically access a website through their terminal 112 or 114 to register in order to start the process of subscribing and making a payment. Initially, a user will be presented with a webpage, for example, that the user inserts their personal details and payment details, for example, by credit card and the amount of time, for example, a month for which they wish to subscribe and the terminal device on which to access the program.

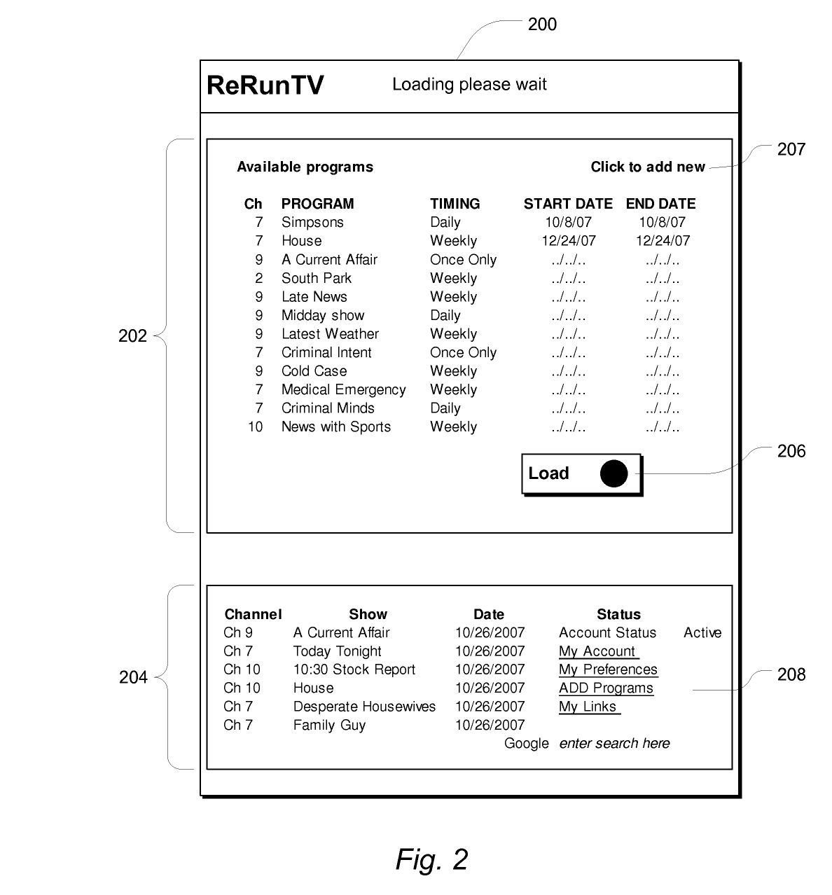

This information is then forwarded over the internet 110 to the server 102. After confirmation of the payment being received and processed at the server 102, the server 102 arranges to transmit software over the internet 110 to the subscriber's terminal which will provide an interface for their terminal. Alternatively, a graphical user interface can be provided at the website. Such an interface 200 is shown in FIG. 2 where at 202 a list of the programs stored at server 102 are available for viewing or listening by the user, or according to the second embodiment, programs that can be recorded. Each of the programs show the television or radio channel on which they were broadcast or will be broadcast, the frequency at which they will be or were shown (under “Timing”), the start date and end dates when they are available to download or times between which the programs can be recorded. For example, “The Simpsons” will be shown everyday starting from 10 Aug. 2007.

On the interface 200, for a subscriber to select programs this may be done in a number of ways. The user may click on any one of the programs 202 and a pop-up window may provide boxes for entry of the date and time of preferred access by the subscriber, for example, and how many episodes where the program is a serial, that the subscriber may want to view. The programs may be a one-off broadcast or multiple broadcasts over the predetermined period. This can also be done through buttons 207 and 206. Another entry method may be a window provided on the interface for entry of the program name, date, frequency and time.

Similarly in the second embodiment, the subscriber selects from a list of available programs on the interface, those programs that he/she wishes to be recorded. The start time, end time, channel, date and program title are already listed. The selections are then made by highlighting or clicking on the programs, for example through button 207. The subscriber then clicks on button 206 to send the request to the server 102.

Multiple entries can be made at the same time, then transmitted to the server 102 when an internet connection is established between the server 102 and the terminal device of the user. Thus, updated changes or requests from the user are only transmitted to the server 102 when connected to the internet. In the meantime, prior to the internet connection being established, the user can store his or her program selections as well as the other features such as start time and day and frequency at the local terminal device, such as 112 or 114. Once the internet connection is established, synchronisation is made between the server 102 and the local terminal device to upload the updated information such as new program selection or changes to the program selections.

The requests for programs or program changes are processed by the server 102 and, provided authorisation is given to the particular requests for the programs and the frequency, start date or time are valid, then the server 102 through its software will download the required access and links to be shown on the user's graphical interface 200 on their terminal device. The links are thus displayed at 204 where six programs have been subscribed to by this particular user and are activated. Shown in the various columns under box 204 is the name of the program, such as “A Current Affair”, “House”, “Desperate Housewives” and the time and date that the program was broadcast by the respective television or radio station, which is listed under “Channel”. Additionally, a column can show the type of subscription for that program. Additionally, the screen may show how much time the subscriber has to watch or listen to the program. All the user has to do to view or listen to the program is click on the particular link at 204, for example click on the “Current Affair” file, and the software together with a processor of the terminal device allows display of the particular program or, if it is an audio file, enables the user to listen to the program. Thus, by clicking on the links at 204 it sends a signal over the internet to the server 102 to actually download and view that program or listen to the program.

In relation to the second embodiment, the screen 200 will be that of the nominated terminal device of the subscriber. Once the program(s) have been recorded, the server 102 can transmit links to the programs to the device and be accessible at 204, so that the subscriber can then access the program(s). Alternatively, the programs can be downloaded for viewing on the nominated terminal device at a particular date and time selected by the subscriber.

Alternatively, the programs can be transmitted in its entirety for local storage at the terminal device so that there is no need for the user to send a request over the internet each time he or she wants to view or listen to the program. Generally, the programs will be available for viewing or listening for up to four weeks. Where a subscription is for a serial that is shown once a week, then automatic downloads of links or the entire program may be made a few hours or a day after the original broadcast or telecast by the particular radio or television network, or after the recording by the server 102. Shown in box 204 is the date (according to the request made by the subscriber) of the particular program for which link was provided for the user to click on in order to view. It can also state what type of subscription, whether it is daily, weekly or fortnightly for each program. Thus, the user can watch the program or listen to the program for any time up to a predetermined time, for example, four weeks of any of the downloaded links.

Box 208 provides links for the subscriber to account status (shown as “active”), their account, program preferences, any added programs and their links.

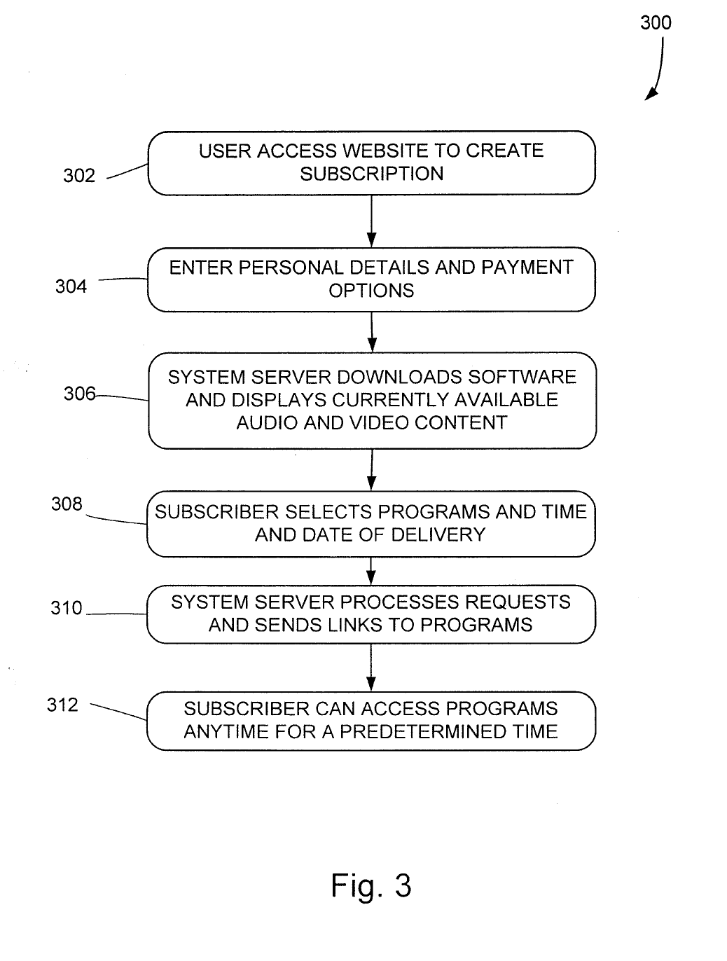

With reference to FIG. 3 there is shown a flow diagram 300 of the process involved in a user obtaining a subscription and eventually having access to the programs made available through the server 102.

At step 302 the user accesses a website associated with the server 102 in order to create a subscription. At step 304 this will include entering on a webpage personal details and payment options for the subscription, for example by credit card.

Once the user clicks on an OK button or similar button then the subscription application and payment details is sent to the server 102 over the internet 110 for further processing by the server 102. After the application has been approved and payment has been received, the server 102 at step 306 downloads software for use on the terminal device of the user, or otherwise makes a graphical user interface available at the website for the subscriber. The software enables an interface 200 to be displayed which in turn displays the currently available audio and video content stored at the server 102 or that can be recorded at a future date and time.

At step 308 the subscriber selects the program or programs from the available programs that they wish to view, listen to or have recorded including a time and date. This is transmitted back to the server 102. A terminal device of the subscriber will have already been nominated.

At step 310 the system server processes the requests or changes made to the programs by the subscriber and through software sends the relevant links to access the programs for display on the graphical interface, for example, on the terminal device at step 310.

Finally, at step 312 the subscriber is able to access the programs at any time for up to a predetermined amount of time as many times as they wish by clicking on the downloaded links. Alternatively, the actual program may be transmitted in full for storage locally in the memory of the terminal device. After a predetermined time access to the stored programs is terminated. For those programs recorded by the server 102, these can be accessed on the nominated terminal device whereby the program(s) are either downloaded to the device, at a set time, or links to the programs are provided as previously discussed.

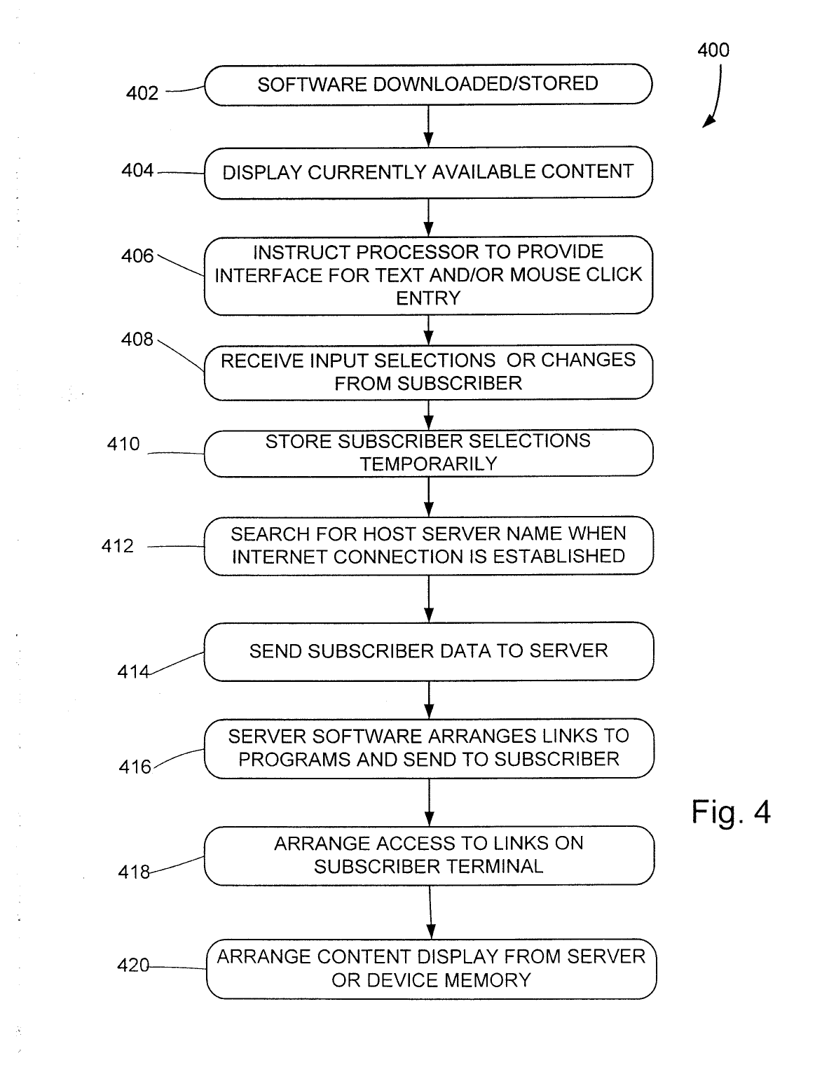

With regard to FIG. 4 there is shown a flow diagram 400 undertaken by the software program that is installed on the terminal device 112, 114, 116 or 118 and also by software used at the server 102. At step 402, after the server 102 processes the new subscription, software resident in memory at server 102 instructs the server 102 to forward software for downloading to the subscriber terminal device and to be stored in an associated memory with that terminal device or enable a GUI to be presented to the subscriber at a website. At step 404 a graphical user interface enabled by the software is displayed on the terminal device (or at a website) and lists the available content of video and audio for a subscriber.

At step 406, when a user wishes to enter a new program (via radio button 206) or make changes to existing subscription programs, the software instructs the processor to provide an interface on the local terminal device for text entry and/or mouse click entry in order to allow the subscriber to provide details on the programs that they wish to see or hear. This includes the name of the program, date and time it is to be made available for viewing and, if it is a serial program, how often subsequent programs are to be transmitted, for example, weekly or fortnightly.

At step 408 once the input is received from the subscriber which is enabled via the software, this is then temporarily stored in memory at step 410 on the local terminal device. At step 412 and in fact at all times, the software searches for a host server name and attempts to connect to the host server 102 by logging in whenever an internet connection is available to the terminal device so as to synchronise the information that has already been entered by the user which is also resident on a user's terminal device memory. Once the internet connection is established then at step 414 the software enables the entered data, which may be for new programs or for changes to program times, for example, to be sent over the internet 110 to the server 102. At step 416 software resident at the server 102 arranges hypertext links to the selected programs to be sent the terminal device or otherwise makes the programs available for viewing. The software at the server 102 also enables the checking of user profiles and arranging payments for subscriptions.

At step 418 the software (that was downloaded to the terminal device) arranges access to the downloaded links to the various selected programs on the subscriber terminal device. Finally, at step 420 the software arranges display of the selected programs from the server 102 or from device memory. Alternatively, in the case of audio files it arranges the retrieval of the audio files for broadcast on the nominated terminal device.

The present invention provides a method and system for allowing subscribers to hear or see programs that they might have missed in the past that were broadcast or telecast on radio and television networks or wished to have recorded, at a later time of their choosing through the subscription service. The subscribers may choose to view or listen to the selected programs at any time and any number of times over a predetermined period.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

The claims defining the invention are as follows:

1. A method of accessing video content or audio content over the internet, the method comprising:
subscribing to receive the video content or audio content;
the subscriber selecting available programs of the video content or audio content using a graphical interface for viewing or listening on a nominated terminal device;
transmitting the selection to a server;
transmitting the selected programs or links to the selected programs from the server to the nominated terminal device whereupon the subscriber is able to access the programs for a predetermined period of time.

2. A method according to claim 1 wherein the selection of available programs by the subscriber is based on programs that are to be recorded and subsequently transmitted to the terminal device.

3. A method according to claim 1 wherein the selection of available programs by the subscriber is based on programs that have previously been broadcast.

4. A method according to claim 1 further comprising transmitting from the server means for providing a subscriber with the graphical interface on the terminal device of the subscriber.

5. A method according to claim 4 wherein the means for providing the graphical interface is a computer program that is downloaded to the subscriber terminal device upon receipt and approval by the server of personal details of, and payment for the subscription, by the subscriber.

6. A method according to claim 4 wherein the means for providing the graphical interface is a computer program that is stored at the server so that the subscriber accesses the interface at a website.

7. A method according to claim 1 further comprising storing the selected programs in a memory of the terminal device when there is no connection available over the internet.

8. A method according to claim 1 further comprising transmitting the selected programs or changes to the selected programs to the server when a connection over the internet is established.

9. A method according to claim 1 wherein the subscriber is able to select, in addition to each program, a time, date and frequency of download of each program to the nominated terminal device, either downloaded as the entire program for local storage on the nominated device or as hyperlinks to each program, available at the server.

10. A system for accessing video content or audio content over the internet, the system comprising:
a server linked to the internet and storing the video content or audio content;
a nominated terminal device of a subscriber to access the video content or audio content;
a graphical interface enabling the subscriber to select available programs from the audio or video content for viewing or listening on the nominated terminal device;
wherein the selection of programs is transmitted over the internet to the server and the server transmits the selected programs or links to the selected programs to the nominated terminal device for access by the subscriber for a predetermined period of time.

11. A system according to claim 10 wherein the selected programs are stored in a memory of the terminal device when there is no connection available over the internet.

12. A system according to claim 10 wherein the server receives the audio and/or video content from servers associated with any one of television networks, radio networks, film studios, or websites associated with any of television networks, radio networks or film studios.

13. A system according to claim 12 wherein the content is received by the server after broadcast or telecast or at the time of by any of the television networks, radio networks or film studios.

14. A system according to claim 10 wherein programs selected by subscribers for recording are recorded and stored in a storage medium at the server, having storage allocated to each such subscriber.

15. A system according to claim 14 wherein the storage medium includes a virtual hard disk recorder in which recordings of content have been made, but which cannot be displayed all simultaneously among the various subscribers in which each subscriber has allocated memory sectors of the recorder available for temporarily storing recorded programs of the subscribers.

16. Computer program means for providing access to video content or audio content over the internet, the computer program means instructing a processor to:
provide a graphical interface to the video or audio content that enables selection of available programs from the content for viewing on or listening on a nominated terminal device;
transmit the selected programs over the internet to a server;
receive from the server the selected programs or links to the selected programs; and
enable the subscriber to access the programs for a predetermined period of time.

17. Computer program means according to claim 16 wherein the selection of programs is based on video content or audio content that has previously been broadcast.

18. Computer program means according to claim 16 wherein the selection of programs is based on video content or audio content that is to be recorded and subsequently transmitted to the terminal device.

19. Computer program means according to claim 16 wherein the computer program means transmitted to the nominated terminal device of a subscriber over the internet.
